(19) United States
(12) Patent Application Publication
(10) Pub. No.: US 2017/0239894 A1
(43) Pub. Date: Aug. 24, 2017

(54) ATTACHMENTS

(71) Applicants: Hexcel Composites SAS, Dagneux (FR); Hexcel Composites Limited, Duxford (GB)

(72) Inventors: Denis Granger, Dagneux (FR); Chris Harrington, Duxford (GB); Asher Ahmed, London (GB); Joseph Gargiuli, Duxford (GB)

(21) Appl. No.: 15/503,784

(22) PCT Filed: Aug. 18, 2015
(86) PCT No.: PCT/EP2015/068929

§ 371 Date: Feb. 14, 2017

(30) Foreign Application Priority Data
Aug. 20, 2014 (EP) EP14181690.0

(51) Int. Cl. B29C 70/22; B29C 65/56; F16B 39/02; B29C 65/00; F16B 5/02; B29C 65/48; B29C 65/72

(52) U.S. Cl. CPC B29C 70/228; B29C 65/48; B29C 65/562; B29C 65/72; B29C 66/721; F16B 5/0241; F16B 39/021; B29L 2031/44

(57) ABSTRACT

Mechanically attaching articles made from composites has problems due to the difference in properties of the composite in the x, y planar direction and the z perpendicular direction, this results in different properties between the composite and the attachment member such as differences in coefficients of thermal expansion which can weaken the joint further leading to differences in moisture uptake which can further reduce the strength and robustness of the joint. The invention relates to the selection of the position of a joint in order to reduce such problems and to operating the moulding process in a way that improves the provision of mechanical attachments such as bolt holes.

The present invention relates generally to the provision of inserts or mechanical attachments or fasteners or bolts in moulding compounds or composite parts that are composed of discontinuous fibrous reinforcement such as glass, carbon or aramid fibres and a thermosetting and/or thermoplastic matrix resin.

Composite materials include a fibrous reinforcement structure and a resin matrix as the two principal components. Composite materials typically have a high strength to weight ratio. As a result, composite materials are used in the aerospace industry where the high strength and relatively light weight of composite structures are of particular importance. The composite materials are isotropic or quasi isotropic in the x, y plane of the sheet but are anisotropic in the z perpendicular direction due to the fibres lying largely in the x,y plane of the sheet. The composites may be made by laying up several layers of a moulding compound to provide a structure with the fibres lying substantially to the plane of the moulding. This leads to the materials having different properties such as mechanical, thermal and reaction to moisture properties in the different directions and can lead to variations in the z direction compared to the x,y plane.

Carbon fibres are a popular fibrous reinforcement for composite materials and the invention is particularly concerned with moulding compounds containing carbon fibres. Carbon fibres are typically provided as a multifilamentary yarn that is commonly referred to as a “tow”. Carbon fibre tows generally contain from 1,000 to 50,000 individual filaments. Commercially available carbon tows contain for example, approximately 3,000 filaments (3K), 6,000 filaments (6K), 12,000 filaments (12K) or 24,000 filaments (24K). A single carbon filament generally has a linear weight that ranges from 0.02 to 0.5 milligrams per metre. The filaments in carbon fibre tows are not twisted and are substantially parallel to each other.

Carbon fibre tows from multiple spools can be woven together to form carbon fibre fabric that is later combined with a resin matrix to form a composite material. Carbon fibre tows are also fed from multiple spools to make unidirectional (UD) fibrous reinforcement, such as UD tape, which is also combined with resin matrix to form a composite material. At some point during the weaving or UD tape production process, the amount of carbon fibre tow left in the spools becomes so small that the spent spools must be replaced with new ones.

The remnant of carbon fibre tow remaining on a spent spool is insufficient for further use in making woven fabric or UD tape. In practice, the remnant of carbon fibre tow that remains on a spent spool will vary in length depending upon the weaving process, the type of fibre reinforcement being made, the linear weight of the filaments and the number of filaments in the tow. Over a period of time the amount of carbon fibre tow remnants that are generated can be substantial. In one embodiment the invention is concerned with the use of the remnants of carbon fibre tows in moulding compositions.

It is known from EP 2179838 and GB 2462996 to provide moulding materials comprising discrete fibre pieces embedded in an epoxy resin matrix, the matrix comprising a thermosetting material such as a curable epoxy resin. The moulding materials can be obtained from carbon fibre tow remnants. These materials and articles produced therefrom will have different properties in the x, y plane and in the z direction.

Such moulding materials may be shaped in a mould and cured at elevated temperature in order to produce a finished shaped article. The resulting articles have high strength and they tend to be quasi isotropic having fibrous elements arranged in random orientations in parallel planes, because the discrete fibre pieces tend to lie in the x, y plane of the article and not in the z axis of the article.

The articles produced from such moulding materials may be useful as components in a wide variety of industries. For example they may be used as components in the aircraft industry, the automobile industry and the furniture and construction industries. In such uses it is often necessary to attach the component to another part of the vehicle, aircraft, article of furniture or another part of the construction. One preferred means of attachment is by metal attachments such as bolts and/or clips. In order to make such an attachment it is necessary to secure the metal attachment within the component typically by forming a through hole in the component for passage of a mechanical attachment such as a bolt. In some instances a sleeve such as a metal sleeve may be provided in the through hole for passage of the metal attachment. However, because of the differential between the properties of the metal of the attachment means and the properties of the moulding material from which the component is made in the direction in which the attachment is made, the position of the attachment can become a weak location within the final structure. This is a particular problem if the article is attached and employed under conditions which experience a temperature and/or moisture cycle such as in aircraft and automotive vehicles that in operation can be exposed to widely different climatic conditions.

Local reinforcement where any hole (or cut-out) is placed in a structural part may be locally reinforced but these problems due to the temperature and moisture cycle can remain. Local reinforcement may also be required in the vicinity of joints, either bonded or bolted and in locations where concentrated loads are joined into the structure.

Joints are often required in transitions between major composite parts. In aircraft, joints are required in articulated fittings on control surfaces as well as on wing and tail components, which require the ability to pivot the element during various operations. Tubular elements such as power shafting often use metal end fittings for connection to power sources or for articulation where changes in direction are needed. Assembly of structures from their constituent parts will usually involve either bonded or mechanically fastened joints or both.

Joints represent a great challenge in the design of structures in general and in composite structures in particular because joints entail interruptions of the geometry of the composite structure of the components that are being joined and the joint often results in material discontinuities, which can produce local highly stressed areas. These problems are exacerbated if the area of the joint is exposed to temperature and/or humidity cycles during operation of the article of which it is a part.

Accordingly, one of the important factors affecting design of composite materials is the load carrying capability and the durability of the joints involving joining one or more components derived from the composite materials with which the invention is concerned. The commonly used types of load carrying joints, involving articles made from composite materials, are:
Mechanically fastened joints.
Adhesive or bonded joints
Combined adhesive and mechanical joints.

According to the present invention there is provided a method, a use, a joint and a part as disclosed herein and/or as defined in any of the of the accompanying claims.

In an embodiment, the present invention relates to joints including a mechanical fastening element possibly in combination with an adhesive element. Various types of joint are illustrated in the following diagram.

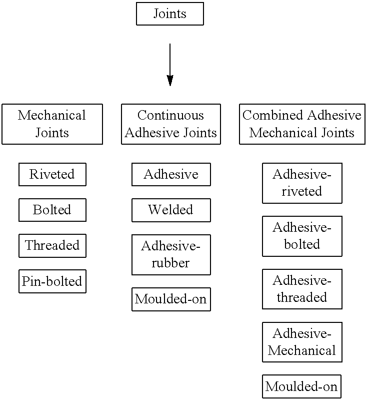

Adhesive joints can be structurally more efficient than mechanically fastened joints because they provide better opportunities for eliminating stress concentrations and advantage can be taken of ductile response of the adhesive to reduce stress peaks. However, in many cases, mechanically fastened joints are required for example, to enable disassembly of the joint for replacement of damaged structure or to provide access to underlying structures. Mechanically fastened joints tend to be preferred over bonded construction in highly critical and safety related applications such as primary aircraft structural components, especially in large commercial transports, since the required level of structural integrity is easier to obtain in mechanically fastened assemblies. As a rule in the aircraft industry, bonded joints prove to be more efficient for lightly loaded/non-flight critical aircraft structures whereas mechanically fastened joints are more efficient for highly loaded structures.

Joints may also combine mechanically fastening with adhesive fastening or bonding. However, in a preferred embodiment, the present invention relates to mechanically fastened joints and in particular provides means to improve the durability of the strength of the joint in environments where they are subject to temperature and/or moisture cycles.

The type of joining to be used in particular circumstances requires careful consideration of several parameters based on a knowledge of the service that the joint is expected to provide.

Some of the advantages and disadvantages of mechanically fastened joints are as follows.

| Advantages | Disadvantages |
|---|---|
| Positive connection | Considerable stress concentration |
| No thickness limitations | Relatively compliant connection |
| Simple process | Relatively poor fatigue properties |
| Simple inspection procedure | Hole formation may cause |
| Simple joint configuration | damage to composite |
| Not environmentally sensitive | Prone to fretting |
| Provides through-thickness | Prone to corrosion |
| reinforcement and not sensitive | Large weight penalty |
| to peel stresses | |
| No residual stress problems | |
| No surface preparation of | |
| component required | |
| Disassembly possible without | |
| component damage | |
| High tolerance to repeated loads | |

The behaviour of composites in articles secured by bolted joints differs considerably from the behaviour of similar articles made from metal. The brittle nature of composites necessitates more detailed consideration to quantify the level of various stress peaks. This is due to the fact that stress concentrations dictate part static strength to a larger extent than in metals. As a result, composite joint design is more sensitive to edge distances and hole spacings than metal joint designs. The different properties of the composite in the x, y plane and the z plane provides further difficulties in both the optimum location and the durability of the mechanical attachment.

Mechanically fastened joints can be divided into two main groups, viz. single row and multi-row designs. Typical lightly loaded non-critical joints require a single row of fasteners. The root joint of an aircraft wing, or a control surface, is an example of a highly loaded joint where the entire load acting on the aerodynamic surface is distributed into another structure. In such a case, the bolt pattern design consisting of several rows distributes the load for more efficient transfer.

The invention is concerned with optimising the location of the joint to reduce or minimise the adverse impact of temperature and/or moisture variations on the strength and durability of the joint.

The primary design considerations for bolted joints include joint strength, fastener type, local reinforcement, joint configuration, holes and pre-load and the retention of these properties over extended use of the structure containing the joint. The design process begins with the determination of the location of the joint and a configuration for the joint. Single lap joints are normally adequate for thin laminates (up to about 5 mm in thickness). Fastener bending and initial bearing failure are areas of concern. Double lap joints are better for cyclic loads and generally stronger.

The use of mechanical fasteners to join composite structures is bound by certain constraints, which do not exist in the design of metallic joints. Care must be taken to select fasteners that are appropriate with the type of composite structures. Special types of fasteners are available for use on composites.

Fastener selection usually raises issues requiring decisions concerning laminate reinforcement, hole sizes and their location, drilling, fastener installation and inspection. The table given below identifies various issues and proven design approaches to each issue. The Table indicates that the complexity of designing bolted joints arises from two primary sources, namely, (a) composite laminates cannot re-distribute high local loads by yielding and plasticity; (b) composites are more easily damaged by drilling and fastener installation than metals.

| Issue | Approach |
|---|---|
| Drilling damage | Closely controlled manufacturing |
| | operations |
| | Inspection of drilled holes |
| High local stresses | Larger fastener diameter |
| | Insert (bushing) |
| | Increased laminate thickness (locally) |
| Preload relaxation | Larger fastener head |
| | Washers (one or both sides) |
| | Limit on installation torque |
| Countersunk head | Avoid, if possible |
| | Increased laminate thickness (locally). |
| Damage induced by installation | Specially designed blind rivets |
| of blind fasteners and drive rivets | Verify joint strength with tests |

Design of local reinforcement of the laminate to resist local stresses is an important step in the design of bolted joints. If reinforcement is required, a proven approach is to increase laminate thickness by addition of plies placed at ±45° and 90° to the primary load direction. A quasi-isotropic laminate provides the best bearing strength in any continuous fibre composite.

Modes of failure in bolted joints of components based in composites can be due to the different properties such as expansion and/or contraction when exposed to temperature and/or humidity cycles.

Fastener requirements for joining composite structures differ from those joining metallic structures. Fastener selection considerations for joining composites include corrosion compatibility, fastener material, strength, stiffness, head configuration, importance of clamp-up, lightning protection, etc. The present invention is concerned with optimising the location of a mechanical attachment member within a component produced from a composite comprising a fibre reinforced moulding material. In particular the invention relates to selecting the position for the provision of a mechanical attachment within a location of the moulding compound in which the fibres lie in substantially parallel planes, preferably substantially parallel planes in the x-y direction. The substantially parallel planes may be formed by laying up sheet moulding compounds one on top of the other. The sheet moulding compounds may comprise fibres or fibrous elements in random or quasi-isotropic arrangement within a plane or sheet or substantially in a plane or x-y plane to form a sheet, layer or isotropic fabric. However in the z direction or other dimension, the fibres are anisotropic. The fibres or fibrous elements may be impregnated with a curable resin. The curable resin may bind or tack the fibres or fibrous elements together to form a sheet or plane in which the fibres or fibrous elements are oriented within the sheet or plane in random or isotropic x-y directions.

In one embodiment the invention relates to aligning the longitudinal axis or line of the mechanical attachment or fastener (also referred to herein as the “bolt line”) in a direction substantially perpendicular to the aforesaid planes, parallel planes or x, y planes.

In a further embodiment there is provided a composite part comprising a cured moulding material in which the fibres lie substantially in a x, y plane of the part and comprising a metal fastener said fastener being arranged along a bolt line, said bolt line extending substantially perpendicular to the x, y plane.

In an alternative embodiment, there is provided a composite part comprising a cured moulding material comprising fibres or fibre elements arranged isotropically in a x,y plane or two-dimensional plane and comprising a metal fastener said fastener being arranged along a bolt line, said bolt line extending substantially perpendicular to the x, y plane.

The metal fastener may comprise steel, stainless steel, aluminium or titanium or a combination of the aforsesaid metals. The fastener may be zinc plated and/or galvanized. The fastener may comprise a screw or bolt optionally in combination with a washer. The fastener is preferably threaded and the composite part comprises corresponding fastener receiving means for receiving the fastener. The fastener receiving means may comprise threaded aperture.

The fastener may additionally be secured by an adhesive. The adhesive may comprise a methacrylate. Preferably the adhesive is a threadlocking adhesive. Suitable thread locking adhesives may comprise methacrylate based adhesives.

The present invention further provides a method of selecting a bolt line in a composite part comprising the steps of
a) obtaining the strain characteristics of the composite
b) selecting a bolt line,
   wherein the bolt line is selected such that the strain and/or associated stress along the bolt line is within a desired range.

In a further embodiment the invention provides the use of the strain characteristics of a cured composite to determine the bolt line to be used for attachment of an article made from the cured composite.

Additionally, the invention relates to a moulding process in which the orientation of fibres in a moulding compound is controlled to provide a volume in an article cured from the moulding compound that optimises the location of a mechanical attachment within the article. The moulding process can be controlled so that the location is provided at a predetermined position in the article. In particular the moulding process may be performed in a press where the temperature and pressure are selected so as to optimise the orientation of the fibres in the x, y plane.

Examples of the strain characteristics which are important in the durability of a joint are thermal expansion strain, moisture induced strain and/or combinations thereof.

In a preferred embodiment the composite is an anisotropic composite material which has isotropic strain in a plane.

In a further embodiment the bolt line is in the isotropic plane. In another embodiment the bolt line is perpendicular to the isotropic or quasi isotropic plane.

In a further embodiment the invention provides a method of connecting one or more parts, at least one part comprising a cured composite by means of a mechanical fastener, comprising selecting a bolt line for the fastener in the composite part by
a) providing the strain characteristics of the composite
b) selecting a bolt line,
   wherein the bolt line is selected such that the strain and/or associated stress along the bolt line is within a desired range.

Preferably the average strain along the bolt line is matched to the strain of the mechanical fastener along its longitudinal axis. The direction of the bolt line in the moulding compound is selected such that the difference between the strain over the bolt line of the compound and the strain of the fastener is minimized.

The difference may be with a range of from 0 to 10%, or from 0.5 to 8%, more preferably from 1 to 3% of the strain of the fastener and/or combinations of the aforesaid ranges.

The thermal expansion effects and also moisture absorption effects affect the torque setting for mechanical fasteners such as bolts or other fasteners. In another embodiment of the invention, there is therefore provided a joint comprising a composite part and a mechanical fastener said mechanical fastener being arranged in said composite part in such a direction that the thermal and/or moisture absorption effects on the torque of the fastener are limited or minimized.

Typically the mechanical fastener is a metal fastener.

The strain characteristics of the composite may be obtained by measuring the thermal expansion coefficient and moisture absorption coefficient on a sample of the cured composite material. These measurements are obtained by measuring the dimensions of a cured sample of the cured composite material using a dilatometer during thermal and/or moisture cycling of the material over a desired or anticipated operating range of the composite. The dilatometer is attached to the sample (in particular strain gauges bonded to the sample as supplied by Instron are suitable as dilatometers) and they enable the calculation of the shear strain, axial strain and transverse strain in response to the dimensional changes in a composite sample due to temperature and/or moisture effect.

These measurements can be used to model the thermal expansion and moisture absorption of the component derived from the cured composite which can be done by using Finite Element analysis. A bolt line can then be selected and the thermal expansion/moisture absorption characteristics can be calculated along the bolt line to determine if these are acceptable. If they are not acceptable, another bolt line orientation can be selected until a line with the acceptable thermal expansion/moisture absorption characteristics is found. Alternatively the information can be used to develop optimum moulding processes.

The strain characteristics of the mechanical fastener may be established by mechanical testing, or by conducting suitable Finite Element analysis.

The fastener may be arranged parallel to or perpendicular to the bolt line.

We have discovered that it is advantageous to select the direction of the bolt line in the compound such that the resin to fibre volume ratio over the volume occupied by the mechanical fastener is minimized. The less resin is present in the volume, the effects of thermal expansion and/or moisture absorption are reduced. The fibre volume ratio can be assessed using computational models, and can be measured using ultrasound, x-ray, resin burn techniques or chemical solvation methods.

A composite thermoset moulding material is used to form the moulded parts that are joined according to the invention, such moulding materials are particularly useful in the production of complex moulded parts. Several types of moulding materials exist which are intended to be used for the formation of moulded parts by way of compression moulding. An example of one such a system is described in EP 0916477.

A particularly useful moulding material is the product available from Hexcel Composites Ltd as HexMC®. HexMC® comprises a liquid epoxy resin matrix in combination with chopped carbon fibres and has a high fibre volume fraction (Vf) between 50 to 65% thus enabling it to be used in the manufacture of a wide range of moulded structural components. HexMC® is the subject of EP 1134314. As these materials are cured the liquid phase becomes more viscous and moulding of one or more layers of the moulding material in a press causes alignment of the fibres and the moulding process can be controlled to enhance the alignment of the fibres in the x, y plane in a way that renders the direction substantially perpendicular to the x, y direction (known as the z direction) suitable for the line of a mechanical attachment.

The moulding material may be a B-staged moulding material comprising discrete fibre pieces embedded in an epoxy resin matrix, said matrix comprising at least one epoxy resin material, at least one further resin material, at least one B-staging agent, at least one curing agent and at least one cure catalyst and/or cure accelerator.

Advantageously, B-staging enables the resin matrix to undergo a transition whereby the viscosity of the matrix increases. Therefore, prior to B-staging the resin matrix is sufficiently mobile such that it is easy to mix whilst following B-staging, the material has a sufficiently high viscosity that moulding of shapes can readily occur without unwanted separation of the resin matrix and the fibres.

Preferably, the B-staging agent is a reactive primary or aromatic diamine. Suitable B-staging agents include any of the following either alone or in combination, isophorone diamine (IPDA), Laromin® C260, Jeffamine® T403, Jeffamine® C230 and Ancamine® 2264. Most preferably the B-staging agent is IPDA. The B-staging agent may be added to the resin matrix in an amount ranging from 2 to 5% w/w of the total resin composition.

The epoxy resin material of the present invention may be selected from any of the commercially available diglycidylethers of Bisphenol-A either alone or in combination, typical materials in this class include GY-6010 (Huntsman Advanced Materials, Duxford, UK), Epon 828 (Resolution Performance Products, Pernis, Netherlands), and DER 331 (Dow Chemical, Midland, Mich.).

The Bisphenol-A epoxy resin material preferably constitutes from 30 to 50% w/w of the total resin matrix. The epoxy resin material employed in the composites used in the present invention is a thermoset material and as such provides a means with which to manipulate further the viscosity and flow characteristics of the moulding material. When employed the further resin material may be a thermosetting resin material and/or a thermoplastic material. The thermosetting resin material of the present invention preferably constitutes 7 to 10% w/w of the total resin matrix.

Another form of composite moulding material that can be used is the product available from Hexcel Composites Ltd as HexMC® or HexForm® which is another product based on scrap fibres which is of high strength as it contains from 50 to 70 wt % of fibre particularly from 55 to 65 wt % fibre.

The invention has been described in relation to mechanical joints however the invention is equally applicable to the provision of joints involving composite materials and which are based on the combination of a mechanical attachment and an adhesive joint and may be used with any of the structural adhesives employed in the aircraft and automotive industries particularly the epoxy or polyurethane based structural adhesives.

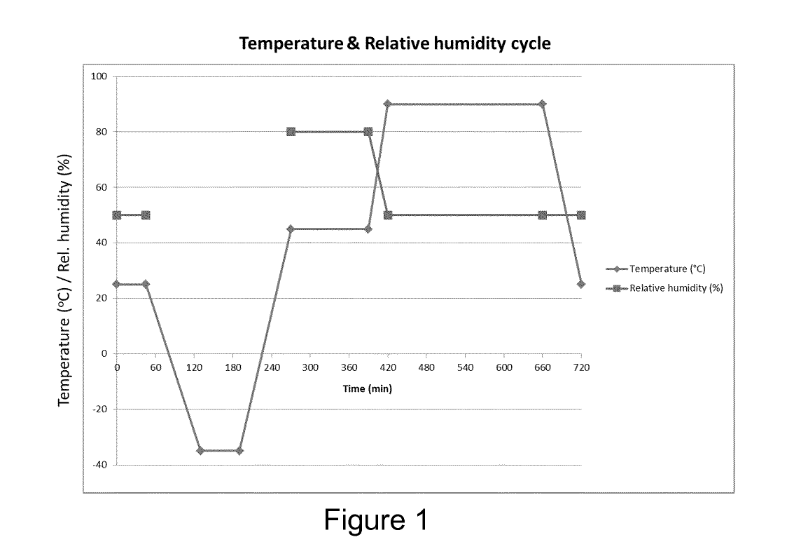

The invention is illustrated by reference to the following examples and with reference to accompanying FIG. 1 which shows a temperature/moisture cycle.

### EXAMPLE 1

HexMC® M77 and HexMC® M81 laminates were manufactured and cured. HexMC® as supplied by Hexcel Corporation is a moulding material containing discrete unidirectional fiber elements which are impregnated with a resin matrix, in this case M77 and M81 resins also available from Hexcel Corporation. The cure/post cure cycles used are as follows.
M77: 2 min/150° C. under 100 bar pressure, no post cure
M81: ageing step in oven 7 min/170° C., cure 1 h/150° C. under 100 bar pressure+post cure 2 h/180° C.

Different laminates were prepared in which the orientation of the fiber elements was varied so that some laminates were isotropic (same distribution of elements in x, y and z direction), whilst other laminates were anisotropic so that the elements were distributed isotropically in the x-y direction, but not in the z direction.

Two laminates were made for each material to allow both in-plan and through thickness measurements to be made. In plan samples could be cut from relatively thin laminates (x=2.3 mm), however through thickness samples required a thicker laminate (x=25 mm). All samples were cut using a diamond tipped water cooled wheel saw. Samples of the cured composite materials were placed in a vacuum oven overnight at 90° C. to remove any moisture.

The reduction in bolted torque performance of bolted HexMC® samples which were subjected to ageing/conditioning cycles was evaluated to determine any detrimental effect on composite thermal expansion coefficient and/or Tg caused by moisture uptake during the cycling. The thermal cycling was found to have minimal effect on the glass transition temperature of both materials. The moisture conditioning was found to degrade both materials performance significantly. However, the samples having a greater alignment of the fibres in the x, y plane as opposed to the z plane were found to enable a more robust and longer lasting mechanical attachment to be obtained.

### EXAMPLE 2

Two HexMC® M81 laminates were manufactured and cured using the same cure schedule as defined in Example 1.

In the first laminate the fiber elements were distributed to form a laminate which was an isotropic laminate (Laminate 1). In the second laminate, the fiber elements were distributed to form a laminate in which the elements were anisotropic in the z-direction but isotropic in the x-y direction (Laminate 2).

Each laminate was drilled to a depth of 22 mm and threaded to accept 5 rows of 6 bolts and washers (so 30 bolts and washers in total for each laminate). The bolts were M8 bolts of 16 mm length manufactured from zinc plated steel (grade 10.9). The washers were 1 mm thick and also manufactured from zinc plated steel (grade 10.). The washer had an inner aperture of 8.4 mm and an outer diameter of 17 mm.

The bolts were applied to the laminates at different torque settings as set out in Table 1 as follows:

TABLE 1
Bolt torque settings before temperature/moisture cycles

| Bolt row | Torque setting (N · m) |
|---|---|
| 1 | 10 |
| 2 | 15 |
| 3 | 20 |
| 4 | 25 |
| 5 | 30 |

The laminates were then each exposed to the temperature and relative humidity cycle variations as shown in FIG. 1. The relative humidity is the ratio of the amount of water vapor in the air at a specific temperature to the maximum amount that the air could hold at that temperature, expressed as a percentage.

The torque settings of the M8 bolts were then checked for each of the laminates. The results are presented in the below Table 2.

TABLE 2
Bolt torque settings after temperature/moisture cycle of FIG. 1

| | Laminate 1 - number of | Laminate 2 - number of |
|---|---|---|
| Bolt row | bolts with reduced torque | bolts with reduced torque |
| 1 | 0 | 0 |
| 2 | 0 | 0 |
| 3 | 0 | 0 |
| 4 | 0 | 0 |
| 5 | 2 | 6 |

1. A method of selecting a bolt line in a composite part comprising the steps of:
a) obtaining the strain characteristics of the composite;
b) selecting a bolt line,
wherein the bolt line is selected such that the strain and/or associated stress along the bolt line is within a desired range.

2. (canceled)

3. A method according to claim 1, wherein the strain characteristics comprise thermal expansion strain, moisture induced strain and/or combinations thereof.

4. A method according to claim 1, wherein the composite is an anisotropic composite material.

5. (canceled)

6. A method according to claim 1, wherein the composite material has isotropic strain in a plane.

7. A method according to claim 6, wherein the bolt line is in the isotropic plane.

8. A method according to claim 1, wherein the fastener is arranged parallel to the bolt line.

9. A method according to claim 1, wherein the fastener is arranged perpendicular to the bolt line.

10. A moulding process in which the orientation of fibres in a moulding compound is controlled to provide a volume in an article cured from the moulding compound that optimises the location of a mechanical attachment within the article.

11. A moulding process according to claim 10 performed in a press in which the conditions optimise the orientation of the fibres in a plane.

12. A method of connecting one or more parts, at least one part comprising a composite, by means of a metal fastener, comprising providing a line for the fastener in the composite part in accordance with claim 1.

13. A method according to claim 12, wherein the one or more parts are connected in combination with an adhesive.

14. A composite part comprising an aperture positioned along a bolt line selected by means of a method as set forth in claim 1.

15. (canceled)

16. (canceled)

17. A composite part comprising a cured moulding material in which the fibres lie substantially in a x, y plane of the part and comprising a metal fastener said fastener being arranged along a bolt line, said bolt line extending substantially perpendicular to the x, y plane.

18. A composite part according to claim 17, wherein the fastener is threaded and the composite part comprises corresponding threaded fastener receiving means for receiving the fastener.

19. A part according to claim 17 wherein the fastener is additionally secured by an adhesive comprising a methacrylate based adhesive composition, preferably a poly(methyl methacrylate) based composition.
